(19) United States
(12) Patent Application Publication
(10) Pub. No.: US 2016/0265374 A1
(43) Pub. Date: Sep. 15, 2016

(54) MOUNTING DEVICE AND MOUNTING METHOD

(71) Applicant: SIEMENS AKTIENGESELLSCHAFT, München (DE)

(72) Inventors: Stefan Bentele, Mülheim an der Ruhr (DE); Ulrich Beul, Essen (DE); Frank Brumbi, Mülheim an der Ruhr (DE); Oliver Ceranski, Mülheim (DE); Manuel Ettler, Nörvenich-Wissersheim (DE); Thomas Helmis, Mülheim an der Ruhr (DE); Markus Hofmann, Castrop-Rauxel (DE); Daniel Lindemann, Mülheim an der Ruhr (DE); Adam Maguire, Oberhausen (DE); Oliver Ricken, Essen (DE); Andreas Stiehm, Remagen-Kripp (DE)

(73) Assignee: Siemens Aktiengesellschaft, Munich (DE)

(21) Appl. No.: 15/033,201

(22) PCT Filed: Sep. 18, 2014
(86) PCT No.: PCT/EP2014/069854

§ 371 Date: Apr. 29, 2016

(30) Foreign Application Priority Data
Nov. 5, 2013 (EP) 13191584.5

(51) Int. Cl. F01D 9/04

(52) U.S. Cl. CPC F01D 9/042; F05D 2220/30; F05D 2230/60; F05D 2240/12

(57) ABSTRACT

A mounting device for mounting a guide blade to be mounted in a blade groove of a turbine, where the mounting unit has a clamping unit and a pressing unit. Here, the clamping unit is designed to produce in the blade groove a non-positive connection in a circumferential direction. The pressing unit is arranged behind the clamping unit in the circumferential direction and the pressing unit is supported against the clamping unit in the circumferential direction. The pressing unit is designed to apply a pressing force by means of a pressing piston in an opposite direction to the circumferential direction in a mounting direction and to transmit said force to the guide blade to be mounted.

### CROSS REFERENCE TO RELATED APPLICATIONS

This application is the U.S. National Stage of International Application No. PCT/EP2014/069854 filed Sep. 18, 2014, and claims the benefit thereof. The International Application claims the benefit of European Application No. EP13191584 filed Nov. 5, 2013. All of the applications are incorporated by reference herein in their entirety.

### FIELD OF INVENTION

The present invention relates to a mounting device and to a mounting method for mounting a guide vane in a vane slot of a turbine.

### BACKGROUND OF INVENTION

In the prior art, it is common for the guide vanes to be moved into their final position in the vane slot of the turbine by means of manually applied hammer blows. This is very demanding in terms of time and force.

### SUMMARY OF INVENTION

The present invention is now based on an object of providing a machine for this procedure.

Said object is achieved by way of a mounting device, and a mounting method as per the independent claims. Advantageous refinements of the invention are specified in the subclaims and described in the description.

The inventive mounting device for mounting a guide vane, which is to be mounted, in a vane slot of a turbine comprises a jamming unit and a caulking unit. In that context, the jamming unit is designed to generate, in the vane slot, a force fit in a circumferential direction. The caulking unit is arranged behind the jamming unit in the circumferential direction and the caulking unit bears against the jamming unit in the circumferential direction. The caulking unit is designed to apply, by means of a caulking piston, a caulking force in a mounting direction opposite to the circumferential direction, and to transmit this force to the guide vane which is to be mounted.

The mounting device according to the invention advantageously makes it possible to simplify and speed up the mounting of the guide vanes. This makes it possible to save costs and working time.

In one advantageous configuration of the mounting device according to the invention, the jamming unit comprises a jamming piston which is provided with a piston bevel and can be moved in a jamming direction against a fork bevel of a jamming fork.

This configuration makes it simple to produce a force fit between the mounting device and the turbine. The arrangement of the jamming piston in the fork also ensures that the vane slot cannot be damaged by the movement of the jamming piston.

In a further advantageous embodiment of the mounting device according to the invention, the jamming unit is fluidically driven. Additionally, in another advantageous embodiment, the caulking unit is fluidically driven. In that context, fluidically encompasses hydraulic or pneumatic drive types.

Thus, the mounting device can be driven by means of common fluid assemblies, as are frequently encountered in production plants.

In a further advantageous embodiment of the mounting device according to the invention, the caulking piston is provided with an endstop part.

The arrangement of the endstop part on the caulking piston simplifies handling of the mounting device according to the invention, since it is not additionally necessary to hold the endstop part in position.

In the mounting method according to the invention, a guide vane, which is to be mounted, is secured in a vane slot of a turbine in that the guide vane, which is to be mounted, is driven, by means of a mounting device according to the invention, along the vane slot in the mounting direction, to a point provided with a caulking piece. The guide vane is, as ever, fixed by means of the caulking piece.

The mounting method according to the invention is quicker and easier for the installer than mounting methods used hitherto for the same purpose.

### BRIEF DESCRIPTION OF THE DRAWINGS

Exemplary embodiments of the invention will be discussed in more detail on the basis of the drawings and the following description. In the figures:

FIG. 1 shows a mounting device according to the invention,

FIG. 2 shows a jamming unit of the mounting device, and

FIG. 3 shows a mounting method according to the invention.

### DETAILED DESCRIPTION OF INVENTION

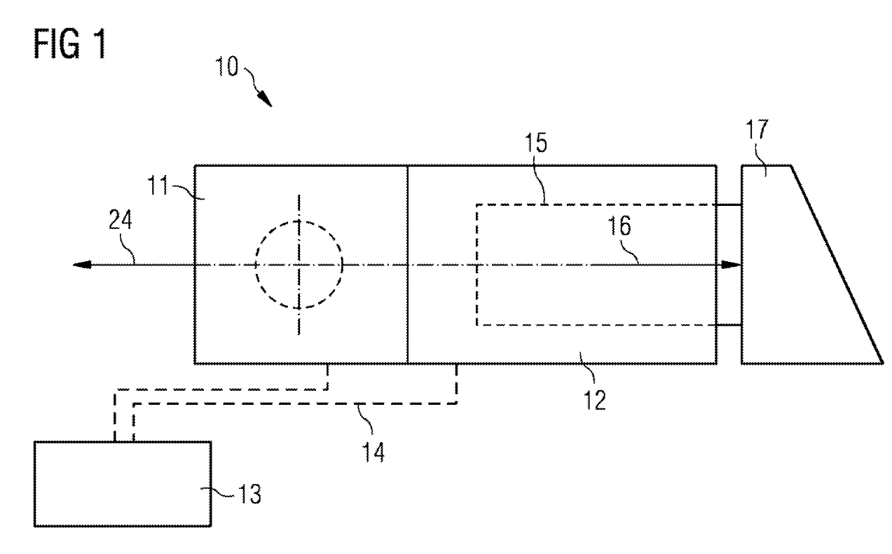

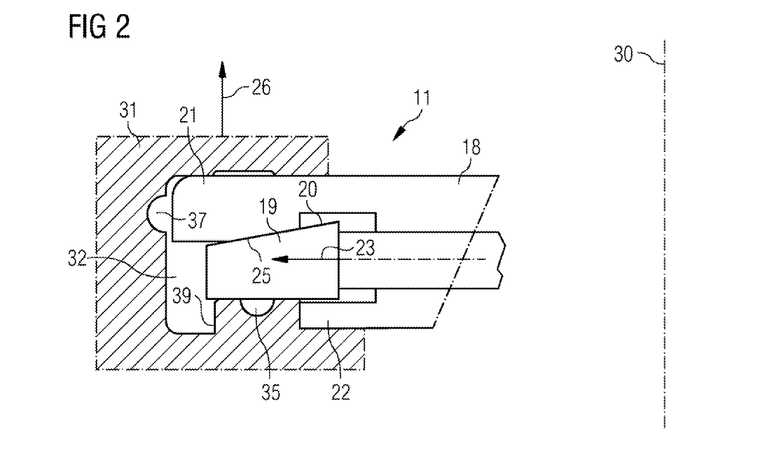

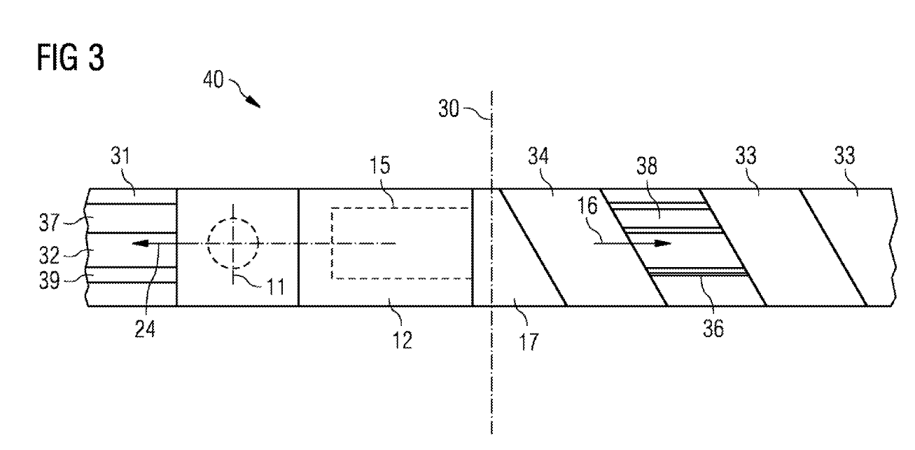

FIG. 1 shows, in an exemplary configuration, a mounting device 10, according to the invention, for mounting a guide vane 34 which is to be mounted. The mounting device 10 according to the invention comprises a jamming unit 11 and a caulking unit 12. The jamming unit 11 is shown schematically, in an exemplary configuration in FIG. 2, in a working position. FIG. 3 shows the mounting device 10 according to the invention in the working position, by way of example while carrying out the mounting method 40 according to the invention.

According to the invention, the jamming unit 11 is designed such that the jamming unit 11 is able to generate, in a vane slot 32, of a turbine 31, for mounting the guide vane 34 which is to be mounted, a force fit in a circumferential direction 24. In that context, the circumferential direction 24 is a direction which, in the working position of the mounting device 10, encircles perpendicular to an axis of rotation 30 of the turbine 31, at a constant distance around the axis of rotation 30. Thus, the circumferential direction 24 corresponds to the profile of the vane slot 32.

According to the invention, the caulking unit 12 is arranged behind the jamming unit 11 in the circumferential direction 24. Thus, the caulking unit 12 bears against the jamming unit 11 in the circumferential direction 24. It is possible to establish a form fit in the circumferential direction 24 between the jamming unit 11 and the caulking unit 12. It is also possible for the jamming unit 11 and the caulking unit 12 to have a common housing by means of which this bearing is effected.

According to the invention, the caulking unit 12 has a caulking piston 15 and is constructed such that the caulking unit 12 is able, by means of the caulking piston 15, to apply a caulking force in a mounting direction 16. In that context, the mounting direction 16 is oriented counter to the circumferential direction 24.

In particular, the jamming unit 11 and/or the caulking unit 12 are fluidically driven. They may be pneumatically or hydraulically driven. The caulking piston 15 of the caulking unit is in particular a pneumatic piston of a pneumatic cylinder or a hydraulic piston of a hydraulic cylinder. In FIG. 1, the mounting device according to the invention is connected via supply lines 14 to a fluid assembly 13, which generates the fluid pressures or, as the case may be, reduced pressures which are necessary for operation of the mounting device 10. The fluid assembly 13 and the supply lines 14 can also form part of the mounting device 10.

In FIG. 1, an endstop part 17 is arranged in front of the caulking piston 15 in the mounting direction 16. The endstop part consists of a material which is softer than the guide vane 34 which is to be mounted, so as not to damage the guide vane.

The endstop part is in particular made of bronze, brass or copper. The endstop part 17 can also form part of the mounting device 10 and be securely connected to the caulking piston 15.

In order to produce the force fit in the circumferential direction, the jamming unit 11 is in particular provided with a jamming piston 19 and a jamming fork 18. In that context, the jamming fork 18 has at least one upper fork arm 21 with a fork bevel 25. In the configuration shown in FIG. 2, the jamming fork 18 also has a lower fork arm 22. In this context, the jamming piston 19 is guided between the upper fork arm 21 and the lower fork arm 22. Here, the jamming piston 19 is arranged displaceably. Here, the jamming piston 19 can be moved in a jamming direction 23 and counter to the jamming direction 23.

In particular, the jamming piston has a piston bevel 20. The piston bevel 20 bears in particular against the fork bevel 25. When the jamming piston 19 is moved in the jamming direction 23, the fork bevel 25 is pushed transversely with respect to the jamming direction 23. In FIG. 2, when the jamming piston 19 is moved in the jamming direction 23, the upper fork arm 21 is urged in the pressing direction 26. In the working position, this presses the upper fork arm 21 against a wall of the vane slot 32.

In the working position of the mounting device 10 according to the invention, the jamming direction 23 runs radially with respect to the axis of rotation 30. The caulking direction 26 runs transversely with respect to the jamming direction 23 and essentially parallel to the axis of rotation 30.

The jamming piston 19 is in particular a pneumatic piston of a pneumatic cylinder or a hydraulic piston of a hydraulic cylinder.

In the examples shown in FIGS. 2 and 3, the vane slot 32 has an axial caulking groove 35 arranged in a projection 39 and a radial caulking groove 37. The configuration of the vane slot 32 shown here thus corresponds to the routine manner. The axial caulking groove 35 is provided for the purpose of inserting an axial caulking piece 36 and the radial caulking groove 37 is provided for the purpose of inserting a radial caulking piece 38. By virtue of the fact that the axial caulking piece 36 is oversized, a guide vane 33 positioned at this point is fixed in the vane slot 32. The purpose of the mounting method 40 according to the invention is to move the guide vane 34, which is to be mounted, to the point in the vane slot 32 with the inserted caulking pieces 36, 38.

FIG. 3 illustrates the mounting method 40 according to the invention. In the mounting method 40 according to the invention, the guide vane 34, which is to be mounted, is secured in the vane slot 32 of the turbine 31.

In the situation shown, two guide vanes 33 are already in their end position in the vane slot 32. The guide vane 34 which is to be mounted is to be pushed in the direction of the already-mounted guide vanes 33. In the final position of the yet to be mounted guide vane 34, the caulking pieces 36 and 38 have in this case already been inserted. This is where the mounting method 40 according to the invention comes in, and the guide vane 34 which is to be mounted is driven by means of the mounting device 10 along the vane slot 32, in the mounting direction 16.

In the illustration, the mounting device 10, and possibly the endstop part 17, have already been moved into the working position. First, the jamming unit 11 is used to create, in the circumferential direction, a force fit between the mounting device 10 and the vane slot 32, in particular by extending the jamming piston 19 in the jamming direction 23. Once the force fit is established, then the caulking piston 15 is actuated and exerts a force in the mounting direction 16. The endstop part 17 is arranged between the caulking piston 15 and the guide vane 34 which is to be mounted. The endstop part 17 transmits the force, applied by the caulking piston 15, in the mounting direction 16 to the guide vane 34 which is to be mounted and thus pushes the latter in the direction of its final position.

Although the invention has been described and illustrated in more detail by way of the preferred exemplary embodiment, the invention is not restricted by the disclosed examples and other variations can be derived herefrom by a person skilled in the art without departing from the scope of protection of the invention.

1. A mounting device for mounting a guide vane, which is to be mounted, in a vane slot of a turbine, wherein the mounting device comprises:
a jamming unit and
a caulking unit,
wherein the jamming unit is designed to generate, in the vane slot, a force fit in a circumferential direction,
wherein the circumferential direction is a direction which, in the working position of the mounting device, encircles perpendicular to an axis of rotation of the turbine, at a constant distance around the axis of rotation,
wherein the caulking unit is arranged behind the jamming unit in the circumferential direction and the caulking unit bears against the jamming unit in the circumferential direction, and
wherein the caulking unit is designed to apply, by means of a caulking piston, a caulking force in a mounting direction opposite to the circumferential direction, and to transmit this force to the guide vane which is to be mounted.

2. The mounting device as claimed in claim 1,
wherein the jamming unit comprises a jamming piston which is provided with a piston bevel and can be moved in a jamming direction against a fork bevel of a jamming fork.

3. The mounting device as claimed in claim 1,
wherein the jamming unit is fluidically driven.

4. The mounting device as claimed in claim 1, wherein the caulking unit is fluidically driven.

5. The mounting device as claimed in claim 1.
wherein the caulking piston is provided with an endstop part.

6. A mounting method, comprising:
securing a guide vane which is to be mounted, in a vane slot of a turbine,
driving the guide vane, which is to be mounted, by means of a mounting device as claimed in claim 1, along the vane slot in the mounting direction, to a point provided with a caulking piece.
